(19) United States
(12) Patent Application Publication
(10) Pub. No.: US 2007/0057616 A1
(43) Pub. Date: Mar. 15, 2007

(54) Electrostatic deflection system and display device

(75) Inventors: Michel Cornelis Josephus Maria Vissenberg, EINDHOVEN (NL); Frank Anton Van Abeelen, Eindhoven (NL); Hubertus Maria Rene Cortenraad, Eindhoven (NL); Antonius Hendricus Maria Holtslag, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/560,008

(22) PCT Filed: Jun. 1, 2004
(86) PCT No.: PCT/IB04/50816

§ 371 Date: Dec. 8, 2005

(30) Foreign Application Priority Data
Jun. 12, 2003 (EP) 03101728.8

(51) Int. Cl. H01J 29/74

(52) U.S. Cl. 313/432; 313/439

(57) ABSTRACT

The invention relates to an electrostatic deflection system for deflecting an electron beam (132), and to a matrix display device provided with such an electrostatic deflection system. The deflection system has deflectors (112, 114) for the horizontal and vertical directions, and a focus electrode (110). By applying a sufficiently high voltage difference of for example several kilo Volts between the focus electrode (110) and at least one of the deflectors (112, 114), a bipotential type focusing electron lens is integrated with the deflection system. Thereby, the system achieves simultaneous deflection of the electron beam (132) and focusing of the electron beam onto a surface (140) to be scanned. In a matrix display device, the electron beam (332) may be kept in focus on the display screen (340) thereby obtaining a relatively small spot size and high image quality. Generally, the display screens divided into a number of portions (344). In operation, each portion is scanned by a separate electron beam (332).

The invention relates to an electrostatic deflection system for deflecting an electron beam. The invention further relates to a cathodoluminescent matrix display device incorporating such an electrostatic deflection system.

Electrostatic deflection is used for scanning an electron beam over a surface in for example cathode ray tubes (CRTs), lithography machines, scanning electron microscopes and some other analytical instruments. Electrostatic deflection is generally achieved by applying a voltage difference (deflection voltage) over a pair of electrodes between which the electron beam passes. The resulting electric field between said electrodes deflects the electron beam. In order to scan the electron beam over the surface, a dynamic deflection voltage is used, i.e. the voltage difference over the electrodes has a time-dependent component.

Typical advantages of electrostatic deflection are the high speed at which the electron beam can be deflected (allowing for a high scanning frequency) and the relatively simple and inexpensive construction.

Alternatively, an electron beam can be deflected using a magnetic field. This has the advantage of an inherently high deflection sensitivity, although the construction of a magnetic deflection system is more complicated.

In order to obtain a high deflection angle using electrostatic deflection, the use of relatively high deflection voltages is generally required. As a result, the strong electric field between the deflection electrodes has a noticeable defocusing effect on the electron beam passing between the electrodes. The spot size of the electron beam on the surface to be scanned thereby becomes comparatively large.

For display applications, electrostatic deflection is conventionally used only for applications in which the deflection angle is not larger than about 45 degrees, such as cathode ray tubes for oscilloscopes. In CRTs for televisions or monitors, a magnetic deflection system has hitherto been used.

An example of a display device that does use electrostatic deflection is the matrix display device known from U.S. Pat. No. 5,189,335. This matrix display device uses a plurality of electron beams, wherein each beam is associated with a portion of the display screen. An electrostatic deflection system is provided for each of the electron beams. Before passing the deflection electrodes, the electron beam is focused by a focusing electrode defining a unipotential electron lens.

Again, deflection defocusing is large. To counter this, in U.S. Pat. No. 5,189,335 the focus electrode is supplied with a dynamic focus voltage, and the electron beam is formed into a line cross-over within one of the deflectors. Although the spot size is homogeneous in this design, it is still relatively large leading to poor image quality and sharpness.

It is an object of the invention to provide an electrostatic deflection system, which allows a reduced spot size of the electron beam on the surface to be scanned.

This object has been achieved by means of the electrostatic deflection system according to the invention as specified in the independent Claim 1. Further advantageous embodiments are specified in dependent Claims 2-6.

The electrostatic deflection system according to the invention forms a focusing electron lens integrated with at least one of the sets of deflection electrodes during operation. A bipotential electron lens field is formed between the focus electrode and at least the first deflection electrodes. This electron lens provides a relatively strong focusing action on the electron beam. For forming a suitable electron lens field, a voltage difference of one or several kV is generally applied between the respective electrodes.

Generally, a bipotential type focusing lens comprises a negative lens portion and a positive lens portion each being positioned essentially on one of the respective electrodes constituting the electron lens field. In the present case, this means that the focusing lens field is distributed from the focus electrode up to the first deflection point, that is, at a point at which the deflecting action of the first deflection electrodes substantially occurs.

As a result, the deflection defocusing effect of the first deflection electrodes may now be compensated for by the focusing lens. Thereby, the electrostatic deflection system according to the present invention achieves a reduction in spot size of the electron beam on the surface to be scanned. Preferably, the converging effect is such that the electron beam is brought in focus on the surface to be scanned.

In operation, the focus electrode generally receives a focus voltage. The first and second deflection electrodes are each preferably provided in the form of a pair of electrodes being positioned on opposite sides of a passing electron beam. The deflection electrodes in a pair both receive a static (DC) deflector voltage, to which a dynamic (AC) deflection voltage is added. The dynamic deflection voltage is applied as a voltage difference between the single electrodes of the pair.

Thus, an electric deflection field is formed through which the electron beam passes, the components of the field being substantially perpendicular to the direction of travel of the electron beam. The first and second directions, in which the electron beam may be deflected, are thus perpendicular to the direction of travel of the electron beam.

According to the invention, generally static voltages in the order of kilo Volts are supplied to the electrode, while the dynamic deflection voltages are in the order of one or a few hundreds of Volts. The dynamic deflection voltages are small compared to the static deflector voltages, and as a result deflection defocusing is comparatively small and beam diverging by the deflection electrodes has been reduced.

The focus electrode generally cooperates with the first deflection electrodes to constitute a focusing electron lens acting in the first direction. Preferably, the focus electrode further cooperates with the second deflection electrodes, so that the focusing electron lens also acts in the second direction. In this case, the spot size may be particularly small as focusing is now possible in both directions.

In a preferred embodiment, the focus electrode and the first and the second deflection electrodes are positioned so that, as seen in a direction of travel of the electron beam, the focus electrode is arranged closest to a means forming the electron beam, and the first and second deflection electrodes are positioned behind the focus electrode.

In this case, the positive portion of the focusing lens is essentially located on the focus electrode, the negative portion of the focusing lens for the first direction is essentially located on the first deflection electrodes and the negative portion of the focusing lens for the second direction is essentially located on the second deflection electrodes. The passing electron beam is first converged, and at the location of the deflection electrodes it is diverged again to a lesser extent.

This embodiment is most advantageous if the spot size should be smaller in one direction than in the other. By suitably setting the static deflector voltages for the first and the second deflection electrodes, the strength of the negative lens portions can be tuned for the first and second directions. That is, the negative lens portions can be about equal for the two directions, or alternatively the negative lens portion can be relatively strong for one direction and relatively weak for the other direction.

In the latter case, setting the static deflector voltages to the same value for both pairs of deflection electrodes, the focusing lens field can be effectively cut off at the deflection electrodes closest to the focus electrode. As a result, the focusing lens has substantially no negative portion for the other set of deflection electrodes.

For example, if the first deflection electrodes are closer to the focus electrode than the second deflection electrodes, the focusing lens for the second direction consists only of a positive portion essentially located on the focusing electrode, and has virtually no negative portion because of the field being cut off. Thus the converging effect of the focusing lens can be as high as possible in the second direction. Moreover, the absence of a negative lens portion gives rise to a significant reduction of lens aberrations contributing to a particuarly small spot size in the second direction.

In a second preferred embodiment, the focus electrode and the first and the second deflection electrodes are positioned so that, as seen in a direction of travel of the electron beam, one of the first and the second deflection electrodes is arranged closest to a means forming the electron beam, and the focus electrode is positioned behind both the first and the second deflection electrodes.

In this embodiment, the deflector electrodes are placed before the focus electrode. In conventional designs, this would cause the beam to be pre-deflected before entering a focusing lens, resulting in the beam entering the focusing lens off-center and at an angle with respect to the main axis of the lens. This results in large lens aberrations and thus poor spot quality, and a low deflection sensitivity as the action of the focusing lens causes the beam to be bent back towards the optical axis.

Such pre-deflection issues have been overcome in the second preferred embodiment. The focusing lens is integrated with the deflectors, in particular is the positive portion of the lens located essentially at the same position as the deflector electrodes. Therefore, the beam is not deflected before entering the focusing lens. The integrated focusing lens allows for a good spot quality and a good deflection sensitivity.

Preferably, the dynamic (AC) deflection voltage is at most 10% of the static (DC) deflection voltage. As a result, diverging of the electron beam by the deflection electrodes is particularly low and an especially small spot size on the screen is obtained.

Preferably, an aperture in the focus electrode has an asymmetric shape, more preferably an elliptic shape. In this case, the strength of the focusing lens portion that is located at or near the focus electrode can be tuned independently for the first and second directions.

It is a further object of the invention to provide a display device having an electrostatic deflection system, wherein an image quality is relatively high.

This object has been achieved by means of the matrix display as specified in the independent Claim 7. Further advantageous embodiments are given in dependent Claims 8 and 9.

Thus, a matrix display device according to the invention comprises a means for generating an electron beam and a display screen with a plurality of picture elements, said display screen being supplied with an anode voltage and being arranged for receiving said electron beam, the electron beam being associated with a portion of said display screen comprising a predetermined number of the picture elements.

The electron beam is deflectable by means of an embodiment of the electrostatic deflection system as set out in the above. The deflection system scans the electron beam over the surface of the display screen, in particular over the portion of the display screen that is associated with the electron beam. By means of the bipotential focusing electron lens, the electron beam is brought in focus on the display screen, so that the spot size of the electron beam on the display screen is particularly small. At the same time, deflection defocusing is largely prevented because part of the lens coincides with the deflector.

These effects leads to a comparatively high image sharpness and quality as compared to prior art display devices equipped with an electrostatic deflection system.

The matrix display device generally relies on the use of a plurality of electron beams, each associated with a portion of the display screen. The electrostatic deflection system is constructed in such way that it is able to operate on each of the electron beams.

In a preferred embodiment, the static voltage for one of said electrodes being positioned closest to the display screen is at least 50% of the anode voltage. That is, if the focus electrode is closest to the display screen, the focus electrode is at least 50% of the anode voltage, and if one of the deflection electrodes is closest to the display screen, the corresponding static deflector voltage is at least 50% of the anode voltage.

In this case, an accelerating field between the last electrode and the display screen is relatively weak. This prevents problems with backscatter electrons.

When an electron beam collides with the display screen, generally about 30% of the incident electrons are backscattered. If the accelerating field is substantial, the backscatter electrons may be deflected back to the screen, where they generate light at unwanted positions leading to a relatively light image background and thus an insufficiently dark black level. The contrast ratio is reduced, possibly even below 10:1 which is unacceptable for display applications. By providing the last electrode with a sufficiently high voltage (i.e. at least 50% of the anode voltage) this problem is largely prevented.

Moreover, a relatively strong accelerating field also influences the beam deflection. The beam is bent back towards its original direction of travel by the accelerating field, so that deflection sensitivity is reduced. Moreover the spot quality is deteriorated, as firstly the beam bending back gives rise to aberrations, and also a larger deflection angle at the deflecftion electrodes is required, which causes additional deflection defocusing. Again, these effects are prevented or at least reduced by setting the static voltage for the last electrodes to a sufficiently high value.

Preferably, the smallest of said static voltages is at least 10% of the anode voltage.

The invention will now be explained and elucidated with reference to the accompanying drawings. The drawings are schematic and not drawn to any scale. In the drawings:

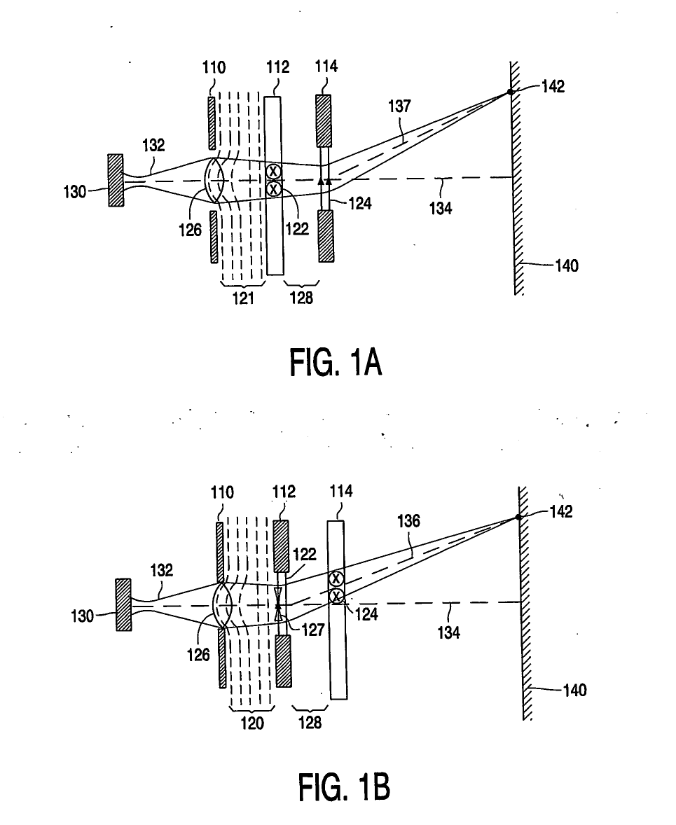

FIGS. 1A and 1B show a top view and a side view of a first embodiment of an electrostatic deflection system according to the invention;

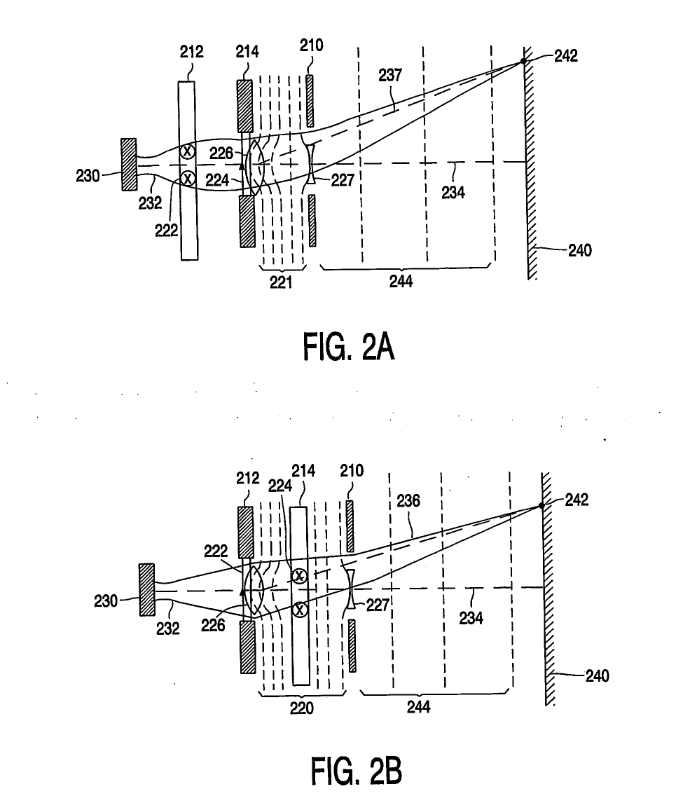

FIGS. 2A and 2B show a top view and a side view of a second embodiment of an electrostatic deflection system according to the invention, and

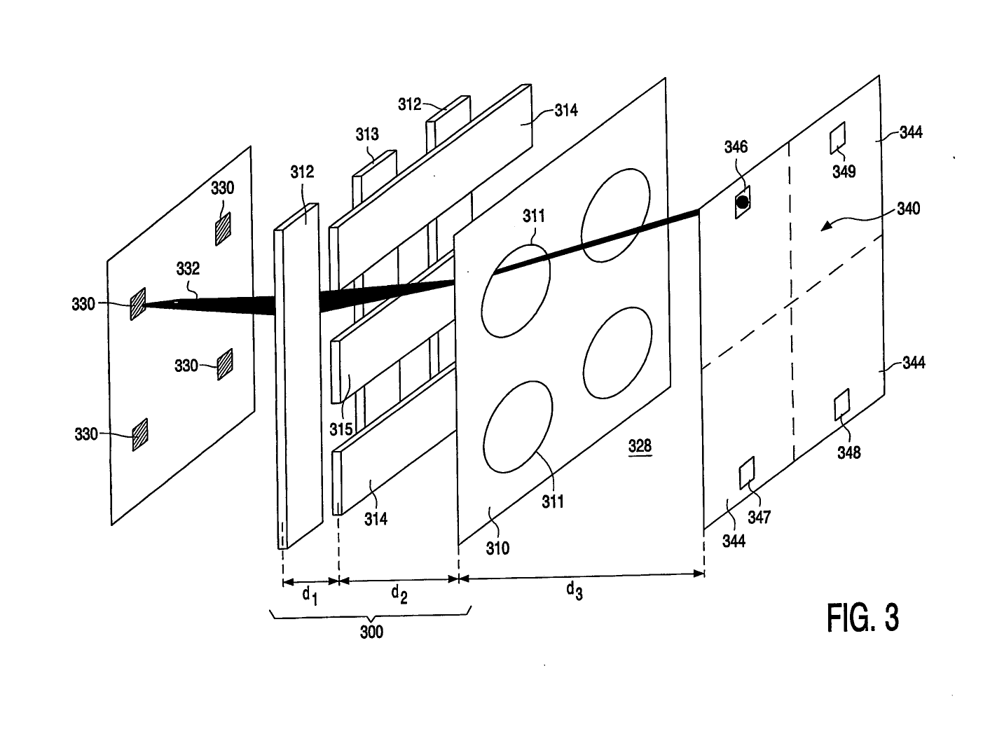

FIG. 3 shows a matrix display device including the second embodiment.

A first embodiment of an electrostatic deflection system according to the invention is shown in FIG. 1. This is a compact deflection system with integrated electron beam focusing, having a simple construction. The system comprises three electronoptical elements, namely, as seen from the electron source 130, a focus electrode 110, a pair of horizontal deflection electrodes (x-deflectors) 112 and a pair of vertical deflection electrodes (y-deflectors) 114. Thus, the focus electrode 110 is closest to the electron source 130, and one of the deflection electrode pairs, namely the y-deflector 114, is closest to the surface 140 to be scanned. Generally, a drift space 144 is provided between the y-deflector 114 and the surface 140.

In operation, the focus electrode 110 receives a focus voltage of several kilo Volts, for example 4 kV. The deflection electrodes 112, 114 receive a static deflector voltage being preferably several kilo Volts larger than the focus voltage, for example 11 kV. Moreover, the deflection electrodes 112, 114 receive a dynamic deflection voltage with an amplitude of for example about 1 kV.

These electronoptical elements cooperate to deflect an electron beam 132. The electron beam 132 is generated by an electron source 130. By supplying the deflection electrodes 112, 114 with a dynamic deflection voltage having a time-dependent component, the electron beam 132 can be scanned over surface 140. Before being deflected, the electron beam 132 travels along an electronoptical main axis 134.

A focusing electron lens is integrated with the deflection system. The electron lens in this embodiment focuses the electron beam 132 such, that it is essentially in focus on the surface 140 in one direction, in this case the vertical direction. The focusing electron lens is constituted by a focusing lens field, indicated by equipotential lines 120 in the horizontal direction and by equipotential lines 121 in the vertical direction.

The focusing lens field is substantially confined between the focus electrode 110 and the x-deflector 112. The voltage difference between said electrodes is appreciably large, i.e. several kilo Volts, so that a bipotential type focusing lens is formed that is sufficiently strong. As the x-deflector 112 and the y-deflector 114 receive the same or a similar static voltage, the space 128 between the x-deflector and the y-deflector is essentially free of an electric field.

A positive portion 126 of the focusing lens is formed on the low-voltage side of the focusing lens field, thus essentially at the location of the focus electrode 110. In the horizontal direction, a negative portion 127 of the focusing lens is formed on the high-voltage side of the focusing lens field, thus at the location of the x-deflector 112. In the vertical direction, the horizontal deflection electrodes 112 shield the focusing lens field from the vertical deflection electrodes 114. As a result, the focusing lens has substantially no negative portion in the vertical direction. This absence of a negative lens portion in the vertical direction gives rise to a significant reduction of lens aberrations and thus a particularly small vertical diameter of the spot 142 on the surface 140.

As stated by way of introduction, the electrostatic deflection by deflection electrodes 112, 114 causes deflection defocusing of the electron beam 132. However, deflection defocusing is a small issue in the embodiments of the present invention, as the (dynamic) deflection voltages are much smaller than the (static) deflector voltage.

The focus electrode 110 comprises an aperture for passing electron beam 132, which aperture may be asymmetrically shaped, preferably elliptically shaped. Thus, in this embodiment, the aperture diameter is smaller in the horizontal direction than in the vertical direction. The positive portion 126 of the focusing lens is stronger in the horizontal direction than in the vertical direction. This compensates for the negative lens portion 127 which is only present in the horizontal direction. This helps to reduce the diameter of the spot 142 on the surface 140 also in the horizontal direction.

The separation of the single electrodes of the x-deflector 112 can be varied so as to tune the deflection system between high deflection sensitivity (requiring small separation) and high focusing lens quality (requiring large separation). The separation of the single electrodes of the y-deflector 114 can be as small as possible, as lens quality is not an issue there. In this first embodiment, the thickness of the x-deflector 112 should be of the order of its separation to secure efficient shielding of the y-deflector 114 from the focusing lens field. Generally, the thickness and separation of the deflectors is in the order of a few millimeters.

The drift space 144 is generally free of an electric field, which means that the surface 140 to be scanned should preferably be at the same static voltage as the deflection electrodes 112, 114. This is advantageous, if an electric field were present in the drift space 144, the electron beam 132 would be bent back towards the direction of the electronoptical main axis 134. Thus, an electrostatic deflection system with a field-free drift space 144 has a comparatively high deflection sensitivity.

Although the first embodiment of the electrostatic deflection system allows for efficient focusing of the electron beam on the surface to be scanned and negligible deflection defocusing, a drawback is that relatively high static deflector voltages of about 10 kV are supplied to the deflection electrodes 112, 114 in order to obtain a field-free drift space 144. As a result, the dynamic deflection voltages have to be comparatively high, requiring more expensive driving electronics, in order to maintain a sufficiently high deflection angle, and/or the deflection electrodes themselves have to be relatively thick.

The second embodiment shown in FIG. 2 allows for the use of lower static deflector voltages of a few kilo Volts, for instance about 3 kV, and consequently lower dynamic deflection voltages can be used. This is possible by changing the order of the focus electrode and the deflection electrodes. The focus electrode 210 is now arranged closest to the surface 240, and the deflection electrodes 212, 214 are arranged between the electron source 230 and the focus electrode 210. Generally, a drift space 244 is provided between the focus electrode 210 and the surface 240.

The electron beam is deflected by the y-deflector 214 so that it travels along a vertical deflection axis 237 between the y-deflector 214 and the surface 240. Moreover, it is deflected by the x-deflector 212 so that it travels along a horizontal deflection axis 236 between the x-deflector 212 and the surface 240.

For this purpose, the x-deflector 212 receives a horizontal deflection voltage. A horizontal deflection field 222 is constituted between the single electrodes of the x-deflector 212. Similarly, the y-deflector 214 receives a vertical deflection voltage, and a vertical deflection field 224 is constituted between the single electrodes of the y-deflector 214.

As set out earlier, the deflection system of the second embodiment does not or hardly suffer from pre-deflection issues deteriorating spot quality. This is caused by the fact that the positive portion 226 of the focusing lens coincides with the respective deflector. Thus, in the horizontal direction the positive portion 226 is located at the horizontal deflection electrodes 212, and in the vertical direction the positive portion 226 is located at the vertical deflection electrodes 214.

Due to its location at the deflection electrodes itself, the positive portion 226 of the focusing lens largely cancels out the effect of deflection defocusing. Moreover, the beam is not deflected before entering the focusing lens. As a result, the integrated focusing lens allows for a good spot quality and a high deflection sensitivity.

In this embodiment, the positive portion 226 of the focusing lens coincides with the deflector. The focusing lens field 221 in the vertical direction is distributed between the y-deflector 214 and the focus electrode 210, and the focusing lens field 220 in the horizontal direction is distributed between the focus electrode 210 and the x-deflector 212.

To achieve this, the static deflector voltages supplied to the two pairs of deflection electrodes are generally not the same in this embodiment. For example, the x-deflector 212 may be supplied with 2.5 kV and the y-deflector 214 may be supplied with 3.5 kV. Again, the voltage difference between the deflection electrodes and the focus electrode 210 is several kilo Volts in order to obtain a sufficiently strong bipotential type focusing lens. The focus electrode 210 is for example supplied with 7 kV.

The y-deflector 214 is closer to the surface 240, however the positive portion 226 of the focusing lens is stronger in vertical direction than in the horizontal direction due to the higher electric field strength of the focusing lens field 221 in the vertical direction. Thus, the focusing lens can be designed such that the electron beam 232 can be in focus on the surface 240 to be scanned, in both directions.

The focusing lens now has a negative portion 227 for both directions, at the position of the focus electrode 210. However, as the lens strength is depenent on the voltage difference between the focus electrode and the deflection electrodes, and this voltage difference is sufficiently large, the focusing action of the lens is not compromised. In this embodiment, the negative lens portion 227 even contributes to increasing the deflection sensitivity as it is able to deflect the electron beam 232 further away from the electronoptical main axis 234.

The reduced static deflector voltages also allow a reduction in the dynamic deflection voltages to be supplied to the deflection electrodes. For example, the voltage difference applied between the electrodes of the x-deflector 212 at the highest horizontal deflection angle is 125 V (superimposed on the static voltage of 2.5 kV), and the voltage difference applied between the electrodes of the y-deflector 214 at the highest vertical deflection angle is 300 V (superimposed on the static voltage of 3.5 kV).

The focus electrode 210 is for example supplied with 6.5 kV and the surface to be scanned is for example supplied with 11 kV. In this case, a small accelerating field is present in drift space 244. However, it has been shown in simulations that such a field does not noticeably bend the deflected electron beam 232 back in the direction of the electronoptical main axis 234.

An electrostatic deflection system according to the invention is preferably applied in a cathodoluminescent display device. In such a display device, the surface to be scanned is a display screen 340 comprising picture elements (pixels) 346 provided with phosphor material. The phosphor material illuminates when it is struck by an electron beam. By scanning one or more electron beams over the pixels 346 of the display screen 340, an image can be displayed on the screen 340. Thereby, a beam current of the electron beam(s) is modulated in accordance with video information that is supplied to the display device.

In FIG. 3, a matrix display device is shown which incorporates an electrostatic deflection system according to the second embodiment as set out earlier.

The pixels 346 on the display screen 340 are grouped in tiles 344, and each tile is associated with an electron source 330. The electron source 330 may be a thermionic cathode, a line cathode or a cold cathode, such as a semiconductor cathode or a field emitter cathode. In the last case, the field emitter cathode may comprise a number of Spindt emitters or carbon nanotubes. Alternatively, the electron source 330 may include an electron compressor like the electron beam guidance cavity as disclosed for example in international patent application WO 2003/041039, which has the advantage that a relatively bright and homogenous electron beam is provided by the exit aperture of the electron source 330. In another alternative embodiment, the electron sources 330 are the extraction apertures of electron beam guiding channels as described in the applicant's unpublished European patent application 02077523.5.

Between the display screen 340 and the electron sources 330, an electrostatic deflection system 300 is arranged, similar to that of the second embodiment set out in the above. Thus, an electron beam 332 first passes the x-deflectors 312, 313, the y-deflectors 314, 315 and then the focus electrode 310, before impinging on the display screen 340. In operation, the deflectors scan an electron beam 332 originating from an electron source 330 over the entire surface of the tile 344 associated with said electron source 330.

The x-deflectors 312, 313 have a thickness of for example 0.2 mm, and the y-deflectors 314, 315 have a thickness of for example 0.6 mm. The spacing d1 between the x-deflectors 312, 313 and the y-deflectors 314, 315 is for example 0.5 mm, and the spacing d2 between the y-deflectors 314, 315 and the focus electrode 310 is for example 1 mm.

The deflectors and the focus electrode 310 in operation constitute a focusing electron lens, which focuses the electron beam 332 on the display screen 340. After passing through the aperture 311 in the focus electrode 310, the electron beam enters a drift space 328 which is essentially free of an electric field.

Because the drift space 328 is essentially free of an electric field, backscatter electrons are hardly deflected back towards the screen, but travel towards the focus electrode 310 and are caught thereby. Moreover, problems with the deflected electron beam 332 being bent back towards the direction of the electronoptical main axis are prevented by means of such a field-free drift space 328. Also, beam aberrations in the drift space 328 are largely prevented.

As stated, the drift space 328 is essentially field-free, i.e. a small electric accelerating field is allowable. This opens the possibility to reduce the focusing voltage supplied to the focus electrode 310. Generally, the potential difference between the display screen 340 and the focus electrode 310 should be less than the energy (in electron Volts) of the bulk of the backscatter electrons. If the length d3 of the drift space 328 is for example 2 cm, it can be calculated that the focusing voltage should be at least half of the anode voltage supplied to the display screen 340. For example, the focus voltage is 6.5 kV, and the anode voltage is 11 kV.

In operation, the dynamic deflection voltage is applied as a voltage difference between neighbouring deflection electrodes 312, 313 and 314, 315. In the design shown in FIG. 3, this causes adjacent electron beams to be deflected oppositely. As a result, when electron beam 332 addresses picture element 346, in neighbouring tiles 344 the picture elements indicated by 347, 348 and 349 are addressed. The pixel driving electronics therefore need to incorporate a special driving scheme, that takes the different scanning sequences for the different screen tiles 344 into account.

An alternative design has two separate sets of horizontal deflection electrodes 312, 313 and vertical deflection electrodes 314, 315 for each tile 344. Although this allows for a simpler driving scheme to be used, more electrodes and electric connections are required, so that this alternative design has a more complicated construction.

The display device is, for example, a 32 inch screen diameter widescreen (16:9 aspect ratio) display tube with a flat display screen. In the case where the electron sources 330 are the extraction apertures of electron beam guiding channels as described in the applicant's unpublished European patent application 02077523.5, a drift space 328 of 20 mm allows a depth of such a display device to be approximately 80 mm. It is estimated that in this case, the tiles 344 on the display screen 340 should have a dimension of about 9 mm by 9 mm.

The tile size is limited by the maximum deflection angle of the electrostatic deflection system 300. In a high-end display device, the requirements on image sharpens and thus the maximum allowable size of the spot of the electron beam on the display screen are such, that a largest angle, through which an electron beam 332 may be deflected by the electrostatic deflection system 300, is about 25 degrees. Moreover, the tile size is particularly small in this case because of the small drift space length of only 20 mm.

Given the viewable screen area for a 32 inch widescreen tube of about 620 mm by 350 mm, the display screen 340 should be divided into approximately 2700 tiles.

Such a display device has cathode ray tube like viewing characteristics while at the same time having a small depth of only 80 mm. The depth of a conventional 32 inch cathode ray tube is about 500 mm.

To decrease manufacturing costs of the display device according to the present invention, larger tiles can be used, which however requires that the drift space between the focus electrode and the display screen is increased in length. Because of the longer drift space, the depth of the display device also increases.

For example, using a drift space of about 100 allows the tile size to be increased to about 43 by 43 when incorporating the electrostatic deflection system of the second embodiment. Thus, the number of tiles is reduced to about 120. However, the depth of the display device increases to about 160 mm.

The drawings are schematic and not drawn to scale. Like elements in the different figures are represented by like reference signs. While the invention has been described in connection with preferred embodiments, it should be understood that the invention should not be construed as being limited to these preferred embodiments. Rather, it includes all variations which could be made thereon by a skilled person, within the scope of the appended claims.

In summary, the invention relates to an electrostatic deflection system for deflecting an electron beam, and to a matrix display device provided with such an electrostatic deflection system. The deflection system has deflectors for the horizontal and vertical directions, and a focus electrode. By applying a sufficiently high voltage difference of for example several kilo Volts between the focus electrode and at least one of the deflectors, a bipotential type focusing electron lens is integrated with the deflection system. Thereby, the system achieves simultaneous deflection of the electron beam and focusing of the electron beam onto a surface to be scanned. In a matrix display device, the electron beam may be kept in focus on the display screen thereby obtaining a relatively small spot size and high image quality. Generally, the display screen is divided into a number of portions. In operation, each portion is scanned by a separate electron beam.

1. An electrostatic deflection system for deflecting an electron beam (132), comprising:
first deflection electrodes (112) for electrostatically deflecting the electron beam (132) in a first direction;
second deflection electrodes (114) for electrostatically deflecting the electron beam in a second direction perpendicular to the first direction, and
a focus electrode (110), cooperating with at least the first deflection electrodes (112), for establishing, in operation, a focusing electron lens field (120, 121) between the focus electrode (110) and the first deflection electrodes (112), said focusing electron lens field (120, 121) focusing the electron beam in at least the first direction.

2. The electrostatic deflection system as claimed in claim 1,
wherein the focus electrode (210) cooperates with both the first (212) and the second deflection electrodes (214), for focusing the electron beam (232) in both the first and the second directions.

3. The electrostatic deflection system as claimed in claim 1,
wherein, when seen in a direction of travel of the electron beam (132), the focus electrode (110) is arranged closest to an electron source (130), and the first and second deflection electrodes (112; 114) are positioned behind the focus electrode (110).

4. The electrostatic deflection system as claimed in claim 1,
wherein, when seen in a direction of travel of the electron beam (232), one of the first and the second deflection electrodes (212; 214) is arranged closest to an electron source (230), and the focus electrode (210) is positioned behind both the first and the second deflection electrodes.

5. The electrostatic deflection system as claimed in claim 1,
wherein the first and second deflector electrodes (112, 114) are each arranged for receiving a static deflector voltage and a dynamic deflection voltage, said dynamic deflection voltage being at most 10% of said static deflector voltage.

6. The electrostatic deflection system as claimed in claim 1,
wherein the focus electrode (110) is provided with an aperture having an elliptical shape.

7. A matrix display device comprising:
an electron source (330) for generating an electron beam (332);
a display screen (340) with a plurality of picture elements (346; 347; 348; 349), said display screen being supplied with an anode voltage and being arranged for receiving said electron beam (332), the electron beam being associated with a portion (344) of said display screen (340) comprising a predetermined number of the picture elements,
wherein the electron beam (332) is deflectable by means of an electrostatic deflection system (300) as specified in claim 1, for scanning the electron beam (332) over the associated portion (344) of the display screen (340), the electron beam being focused on the display screen by means of the focusing electron lens.

8. The matrix display as claimed in claim 7, wherein the focus electrode (310), the first deflector electrodes (312, 313) and the second deflector electrodes (314, 315) are arranged for receiving at least a static voltage, the static voltage for one of said electrodes (310) being positioned closest to the display screen (340) being at least 50% of the anode voltage.

9. The matrix display as claimed in claim 8, wherein the smallest of said static voltages is at least 10% of the anode voltage.
